(19) United States
(12) Patent Application Publication
(10) Pub. No.: US 2021/0111500 A1
(43) Pub. Date: Apr. 15, 2021

(54) CONNECTOR ASSEMBLY METHOD, IN-VEHICLE EQUIPMENT ASSEMBLY METHOD, CONNECTOR ASSEMBLY, AND IN-VEHICLE EQUIPMENT

(71) Applicant: HIROSE ELECTRIC CO., LTD., Kanagawa (JP)

(72) Inventors: Kentaro DOI, Kanagawa (JP); Akio TSUBOI, Kanagawa (JP); Tsubasa SHIMIZU, Kanagawa (JP)

(21) Appl. No.: 17/064,643

(22) Filed: Oct. 7, 2020

(30) Foreign Application Priority Data
Oct. 15, 2019 (JP) 2019-188556

(51) Int. Cl. H01R 9/26; H01R 13/508; H01R 13/631

(52) U.S. Cl. CPC H01R 9/2675; H01R 2201/26; H01R 13/6315; H01R 13/508

(57) ABSTRACT

A connector assembly method which includes connecting an external connector fixed to a case of equipment and an internal connector on an internal substrate in the case. A lead extending inward of the case is provided at the external connector, a contact terminal is provided in a socket opening formed at the internal connector, and the connecting the external connector and the internal connector includes inserting a tip end side of the lead into the socket opening in such a manner that the socket opening of the internal connector and a tip end of the lead of the external connector relatively approach each other.

### CROSS-REFERENCE TO RELATED APPLICATION

This application claims priority from Japanese Patent Application No. 2019-188556 filed with the Japan Patent Office on Oct. 15, 2019, the entire content of which is hereby incorporated by reference.

### BACKGROUND

### 1. Technical Field

One aspect of the present disclosure relates to a connector assembly method, an in-vehicle equipment assembly method, a connector assembly, and in-vehicle equipment.

### 2. Related Art

In-vehicle equipment such as an inverter is used under harsh environment requiring strength, waterproofing properties, heat resistance, and dust resistance as compared to general equipment. An external connector is fixed to a case of the in-vehicle equipment. An internal substrate in the case is connected to the external connector. Connection between the external connector and the internal substrate is made by, e.g., screwing of a lead of the external connector to the internal substrate, soldering of the lead of the external connector to a though-hole of the internal substrate, or cable connection of the external connector to an internal connector on the internal substrate. Considering assemblability, a method in which a single-core terminal of an external connector is sandwiched by clip-shaped terminals on an internal substrate has been also proposed (see, e.g., JP-A-2017-157418).

### SUMMARY

A connector assembly method which includes connecting an external connector fixed to a case of equipment and an internal connector on an internal substrate in the case. A lead extending inward of the case is provided at the external connector, a contact terminal is provided in a socket opening formed at the internal connector, and the connecting the external connector and the internal connector includes inserting a tip end side of the lead into the socket opening in such a manner that the socket opening of the internal connector and a tip end of the lead of the external connector relatively approach each other.

### BRIEF DESCRIPTION OF DRAWINGS

FIG. 1 is a perspective view of an external connector and an internal connector of the present embodiment;

FIG. 2 is a perspective view of the external connector of the present embodiment;

FIG. 3 is a perspective view of the internal connector of the present embodiment from above;

FIG. 4 is a perspective view of the internal connector of the present embodiment from below;

FIG. 5A is a perspective view illustrating a connector assembly method of the present embodiment;

FIG. 5B is a perspective view illustrating the connector assembly method of the present embodiment;

FIG. 6 is a perspective view illustrating the method for connecting an external connector and an internal substrate in a first comparative example;

FIG. 7 is a perspective view illustrating the method for connecting an external connector and an internal substrate in a second comparative example;

FIG. 8 is a perspective view illustrating the method for connecting an external connector and an internal substrate in a third comparative example;

FIG. 9 is a perspective view of an external connector of a variation;

FIG. 10 is a perspective view of an internal connector of the variation;

FIG. 11A is a perspective view illustrating a connector assembly method of the variation; and

FIG. 11B is a perspective view illustrating the connector assembly method of the variation.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In recent years, it has been demanded not only for the in-vehicle equipment but also for other types of equipment, such as industrial equipment, to reduce the size of the equipment and simplify the process of connecting the external connector and the internal substrate. However, in screwing of the lead and soldering of the lead, the process of connecting the external connector and the internal substrate is complicated. In cable connection, a component cost increases, and a cable installation space is necessary in the case. In the method described in JP-A-2017-157418, the external connector is connected to the internal substrate from a direction perpendicular thereto. Thus, the single-core terminal becomes long and the equipment becomes large as a whole, considering, e.g., the height dimension of an electronic component on the internal substrate. Moreover, the terminals are connected in an exposed state, and for this reason, it is difficult to ensure the dust resistance. For this reason, such a connection method is not suitable for the equipment used under the harsh environment.

One object of the present disclosure is to provide a connector assembly method, an in-vehicle equipment assembly method, a connector assembly, and in-vehicle equipment for realizing size reduction in equipment used under harsh environment and simplification of a connection process.

A connector assembly method according to one aspect of the present disclosure includes connecting an external connector fixed to a case of equipment and an internal connector on an internal substrate in the case. A lead extending inward of the case is provided at the external connector, a contact terminal is provided in a socket opening formed at the internal connector, and the connecting the external connector and the internal connector includes inserting a tip end side of the lead into the socket opening in such a manner that the socket opening of the internal connector and a tip end of the lead of the external connector relatively approach each other.

In the connector assembly method of one aspect of the present disclosure, the tip end side of the lead of the external connector is inserted into the socket opening of the internal connector, and in this manner, the lead and the contact terminal contact each other and the external connector and the internal substrate are electrically connected to each other. With this configuration, size reduction in the equipment is realized, and connection between the external connector and the internal substrate is simplified. Further, the contact terminal and the tip end side of the lead are housed in the socket opening, and therefore, the dust resistance is ensured. Thus, even in a case where the equipment is used under the harsh environment, connection between the external connector and the internal substrate is maintained.

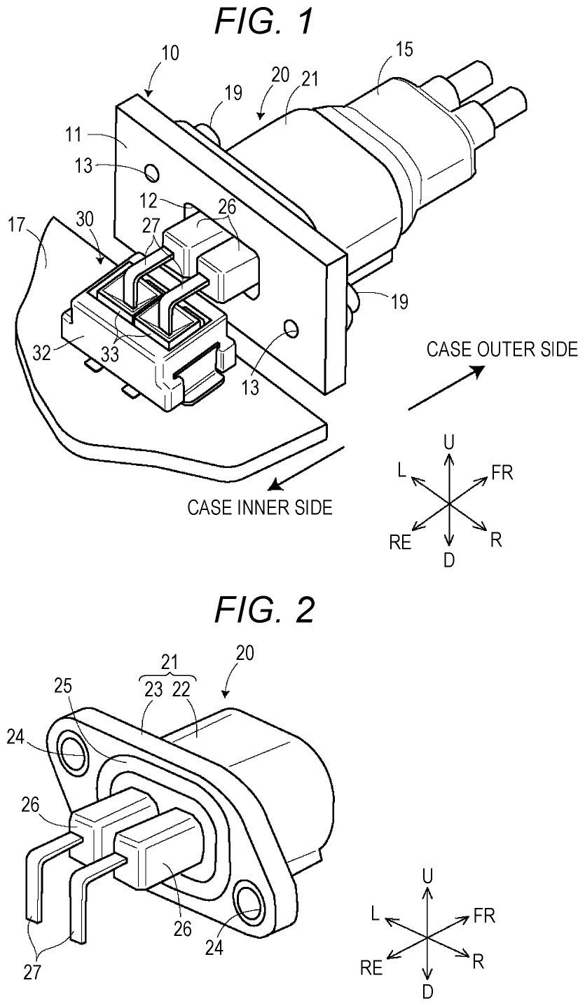

Hereinafter, the present embodiment will be described in detail with reference to the attached drawings. FIG. 1 is a perspective view of an external connector and an internal connector of the present embodiment. In description below, FR, RE, U, D, L, and R each indicate a front direction, a rear direction, an upward direction, a downward direction, a left direction, and a right direction. Note that for the sake of convenience in description, FIG. 1 illustrates only part of a case and an internal substrate.

As illustrated in FIG. 1, the external connector 20 is an I/F connector fixed to a side wall 11 of the case 10 of in-vehicle equipment. A cable connector 15 extending from external equipment such as a battery is connected to the external connector 20. A housing 21 of the external connector 20 is screwed to the side wall 11 of the case 10 with a pair of fixing bolts 19. A though-hole 12 is formed at the side wall 11 of the case 10. A pair of support portions 26 protrudes inward of the case 10 from a rear end portion of the housing 21 through the though-hole 12. Each support portion 26 supports a right-angle bus bar (lead) 27. The external connector 20 is connected to the internal connector 30 on the internal substrate 17 through the bus bars 27.

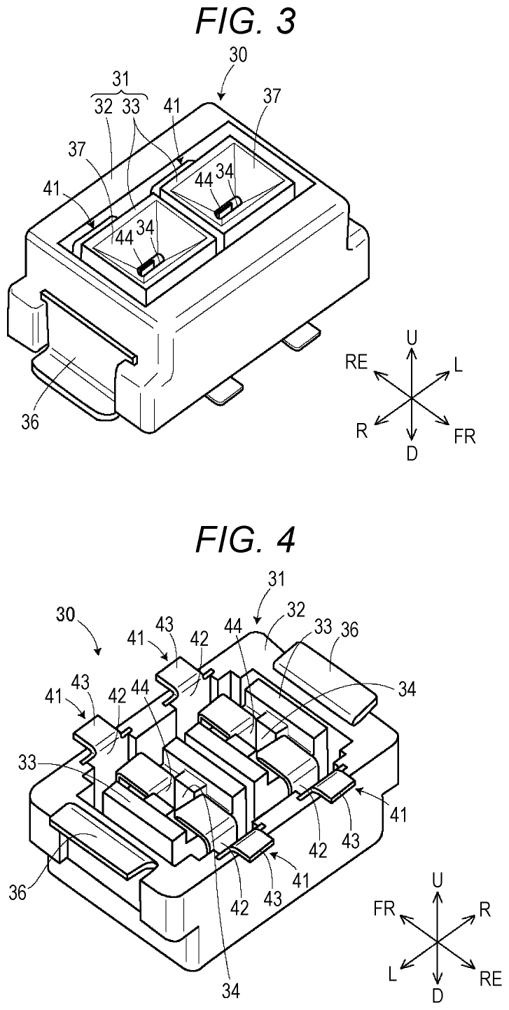

The internal connector 30 is a socket connector (a floating connector) having a floating structure. In the internal connector 30, a pair of movable housings 33 is movably housed in a rectangular frame-shaped fixed housing 32. Socket openings 34 (see FIG. 3) are formed at upper surfaces of the pair of movable housings 33. Multiple contact terminals 44 (see FIG. 3) contacting the pair of bus bars 27 are provided in the socket openings 34. The bus bars 27 of the external connector 20 are inserted into the socket openings 34 of the internal connector 30 so that the internal connector 30 and the external connector 20 can be connected to each other. Thus, a process such as screwing or soldering is not necessary, and therefore, the process of connecting the internal connector 30 and the external connector 20 is simplified.

When the internal substrate 17 is assembled in the case 10, the assembly position of the internal substrate 17 is adjusted by, e.g., a wall surface of the case 10 or a guide pin. However, it is difficult to completely eliminate position displacement between the case 10 and the internal substrate 17. Moreover, when the external connector 20 is fixed to the case 10 and when the internal connector 30 is mounted on the internal substrate 17, slight position displacement is caused. In this case, position displacement between the bus bar 27 and the socket opening 34 is caused. On this point, in the present embodiment, the internal connector 30 has the floating structure, and therefore, the movable housings 33 follow the bus bars 27. Thus, even when position displacement between the bus bar 27 and the socket opening 34 is caused, the bus bar 27 can be easily inserted into the socket opening 34.

Hereinafter, the external connector and the internal connector will be described with reference to FIGS. 2 to 4. FIG. 2 is a perspective view of the external connector of the present embodiment. FIG. 3 is a perspective view of the internal connector of the present embodiment from above. FIG. 4 is a perspective view of the internal connector of the present embodiment from below.

As illustrated in FIG. 2, the external connector 20 includes the high-heat-resistance high-strength resin housing 21 attached to the side wall 11 (see FIG. 1) of the case 10. The housing 21 has a tubular portion 22 to which the cable connector 15 (see FIG. 1) is attached and a flange portion 23 projecting outward of a rear end portion of the tubular portion 22 in a radial direction. The tubular portion 22 extends in a front-rear direction. The tubular portion 22 is formed in a rounded rectangular shape having a wide right-left width as viewed in the section. In the tubular portion 22, a fitting port facing the housing shape of the cable connector 15 is formed. The flange portion 23 has a substantially parallelogram shape as viewed from the front. Insertion holes 24 for screwing are formed at a pair of opposing portions of the flange portion 23.

The pair of support portions 26 supporting the pair of bus bars 27 is provided at the rear end portion of the housing 21. The support portions 26 in a pair are adjacent to each other in a right-left direction, and protrude backward of the rear end portion of the housing 21. The pair of bus bars 27 extends from rear ends of the pair of support portions 26. A tip end side of the pair of bus bars 27 is bent perpendicularly to a base end side of the pair of bus bars 27. Note that “perpendicularly” is not limited to precise perpendicularity, but also includes a substantially perpendicular state which can be taken as perpendicular. A waterproof seal 25 is provided at the periphery of the pair of support portions 26. The waterproof seal 25 liquid-tightly seals between the side wall 11 of the case 10 and the housing 21.

As illustrated in FIGS. 3 and 4, the internal connector 30 includes a high-heat-resistance high-strength resin socket housing 31 attached to the internal substrate 17 (see FIG. 1) housed in the case 10. The socket housing 31 has the fixed housing 32 fixed to the internal substrate 17 and the pair of movable housings 33 placed in the fixed housing 32. The fixed housing 32 is formed in a rectangular frame shape having a wide right-left width. A pair of fixing brackets 36 is provided at both ends of the fixed housing 32 in the right-left direction (a longitudinal direction). The fixed housing 32 is, by soldering, fixed to the internal substrate 17 (see FIG. 1) with the pair of fixing brackets 36.

The pair of movable housings 33 is formed in a rectangular block shape as viewed from above. The movable housings 33 in a pair are placed next to each other in the right-left direction in the fixed housing 32. The upper surface of each movable housing 33 is recessed in a truncated pyramid shape. At the center of such a recess, the socket opening 34 penetrating the movable housing 33 in an upper-lower direction is formed. The recess of the upper surface of the movable housing 33 forms a guide surface 37. The guide surface 37 guides the tip end side of the bus bar 27 toward the socket opening 34. Each movable housing 33 is coupled to the fixed housing 32 through a pair of floating springs 41. By the pair of floating springs 41, each movable housing 33 is supported in a floating state.

The floating spring 41 is formed in such a manner that a metal piece is bent. The floating spring 41 supports the movable housing 33 from below. The floating spring 41 is bent in a U-shape to enter a clearance between the fixed housing 32 and the movable housing 33. A mounting portion 43 extends outward of the fixed housing 32 from a bent portion 42 of the floating spring 41. Further, the contact terminal 44 protrudes inward of the socket opening 34 from the bent portion 42 of the floating spring 41. With this configuration, four mounting portions 43 are provided at the periphery of the fixed housing 32. Further, clip-shaped terminals as a pair of contact terminals 44 are formed in the socket opening 34 of each movable housing 33.

Each mounting portion 43 is, by soldering, fixed to an electrode pad (not shown) of the internal substrate 17. With this configuration, the internal connector 30 is electrically connected to a processing circuit of the internal substrate 17. The bus bar 27 (see FIG. 2) is inserted into the socket opening 34, and in this manner, is sandwiched by the pair of contact terminals 44 in the socket opening 34. Even in a case where the in-vehicle equipment is used under harsh environment, contact reliability is improved by contact among the contact terminals 44 and the bus bar 27 at multiple points. Moreover, by the floating springs 41, position displacement between the bus bar 27 and the socket opening 34 is absorbed. Further, by the floating springs 41, vibration transmitted to the in-vehicle equipment is absorbed. With this configuration, failure in contact among the bus bar 27 and the contact terminals 44 is reduced.

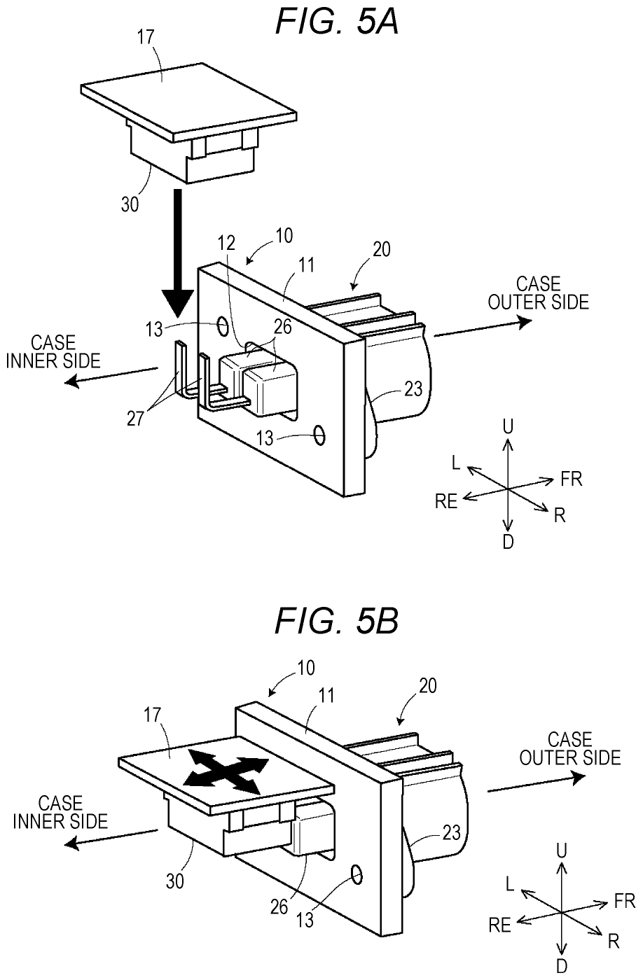

A connector assembly method will be described with reference to FIGS. 5A and 5B. FIGS. 5A and 5B are perspective views illustrating the connector assembly method of the present embodiment. Note that for the sake of convenience in description, FIGS. 5A and 5B illustrate only part of the case and the internal substrate.

As illustrated in FIG. 5A, the external connector 20 is fixed to the side wall 11 of the case 10 of the in-vehicle equipment. In this case, a pair of screw holes 13 is formed at the side wall 11 of the case 10. The pair of screw holes 13 is formed at positions corresponding to the pair of insertion holes 24 (see FIG. 2) of the flange portion 23 of the external connector 20. The pair of fixing bolts 19 (see FIG. 1) is screwed into the pair of screw holes 13 through the pair of insertion holes 24, and in this manner, the external connector 20 is fixed to the side wall 11 of the case 10. The pair of bus bars 27 extends inward of the case 10 from the external connector 20 through the though-hole 12 of the side wall 11. The case 10 is placed in a vertically-inverted state. Thus, the tip end side of the pair of bus bars 27 faces up.

After the external connector 20 has been fixed to the side wall 11 of the case 10, the internal connector 30 on the internal substrate 17 is positioned above the pair of bus bars 27. The internal substrate 17 is also vertically inverted. Thus, the internal connector 30 on an upper surface of the internal substrate 17 faces down. The pair of socket openings 34 (see FIG. 3) at an upper surface of the internal connector 30 is, above the case 10, positioned corresponding to tip ends of the pair of bus bars 27 of the external connector 20. Then, the internal substrate 17 is lowered toward the case 10. In this manner, the pair of socket openings 34 of the internal connector 30 approaches the tip ends of the pair of bus bars 27 of the external connector 20.

The internal substrate 17 is lowered along the wall surface of the case 10. Note that the accuracy of positioning between the case 10 and the internal substrate 17 is not sufficient. For this reason, it is difficult to position the pair of socket openings 34 of the internal connector 30 relative to the pair of bus bars 27 of the external connector 20. On this point, in the present embodiment, the tip ends of the pair of bus bars 27 of the external connector 20 come into contact with the guide surfaces 37 at the periphery of the pair of socket openings 34 of the internal connector 30, and accordingly, the tip ends of the pair of bus bars 27 are guided to the pair of socket openings 34 by the guide surfaces 37. With this configuration, even when position displacement between the bus bar 27 and the socket opening 34 is caused, the tip end side of the pair of bus bars 27 is easily inserted into the pair of socket openings 34.

As illustrated in FIG. 5B, the movable housings 33 (see FIG. 3) of the internal connector 30 are moved to follow tip end positions of the pair of bus bars 27 of the external connector 20. By movement of the movable housings 33 relative to the fixed housing 32, position displacement of the external connector 20 relative to the case 10, position displacement of the internal connector 30 relative to the internal substrate 17, and position displacement of the internal substrate 17 relative to the case 10 are absorbed. When the tip end side of the pair of bus bars 27 of the external connector 20 is inserted into the pair of socket openings 34 of the internal connector 30, the contact terminals 44 (see FIG. 3) in the pair of socket openings 34 and the pair of bus bars 27 contact each other. A connector assembly is formed by connection between the external connector 20 and the internal connector 30. Thereafter, the internal substrate 17 is placed on the case 10 by, e.g., screwing. In this manner, the in-vehicle equipment is assembled.

As described above, in the connector assembly method of the present embodiment, the tip end side of the pair of bus bars 27 of the external connector 20 is inserted into the pair of socket openings 34 of the internal connector 30, and in this manner, the external connector 20 and the internal substrate 17 can be easily connected to each other. Moreover, in a state in which the case 10 is vertically inverted, the internal substrate 17 is assembled with the case 10 from above. Thus, on, e.g., an in-vehicle equipment production line, workability in the process of assembling the internal substrate 17 with the case 10 can be improved. Further, automation of the process of assembling the internal substrate 17 with the case 10 by an automatic machine can be realized.

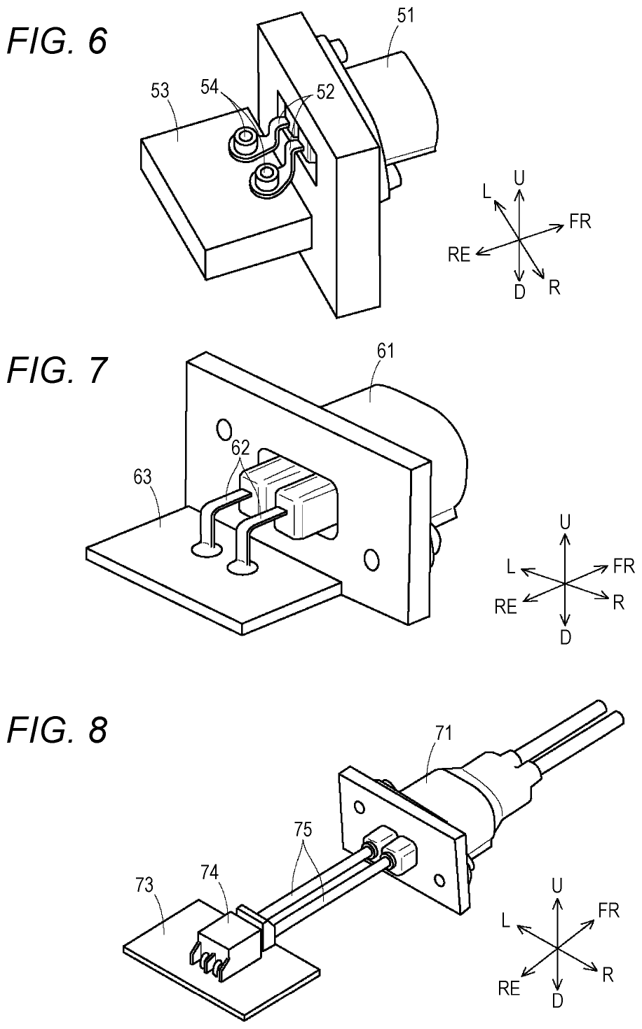

Subsequently, the methods for connecting an external connector and an internal substrate in first to third comparative examples and the method for connecting the external connector and the internal substrate in the present embodiment will be described in comparison with each other. FIG. 6 is a perspective view illustrating the method for connecting the external connector and the internal substrate in the first comparative example. FIG. 7 is a perspective view illustrating the method for connecting the external connector and the internal substrate in the second comparative example. FIG. 8 is a perspective view illustrating the method for connecting the external connector and the internal substrate in the third comparative example.

The connection method of the first comparative example as illustrated in FIG. 6 is a method in which a pair of bus bars 52 of an external connector 51 is screwed to an internal substrate 53. In this connection method, the pair of bus bars 52 is bent in a crank shape as viewed from the side. A pair of fixing screws 54 is screwed to screw holes of the internal substrate 53 through through-holes of tip end portions of the pair of bus bars 52. The connection method of the second comparative example as illustrated in FIG. 7 is a method in which a pair of bus bars 62 of an external connector 61 is soldered to an internal substrate 63. In this connection method, the pair of bus bars 62 is bent in a right-angle shape. Tip end portions of the pair of bus bars 62 inserted into through-holes of the internal substrate 63 are soldered to the internal substrate 63.

The connection method of the third comparative example as illustrated in FIG. 8 is a method in which an external connector 71 and an internal connector 74 on an internal substrate 73 are cable-connected to each other. In this connection method, one end of a cable 75 is attached to the external connector 71. Further, the other end of the cable 75 is attached to the internal connector 74. These connection methods of the first to third comparative examples and the connection method of the present embodiment were evaluated in terms of assemblability, automation, repair (ease of replacement), space saving, contact reliability, and vibration resistance. As a result, evaluation results shown in Table 1 below were obtained. In Table 1, A indicates a highest rating, B indicates a high rating, C indicates an intermediate rating, and D indicates a low rating.

TABLE 1

| | | | | SPACE | CONTACT | VIBRATION |
|---|---|---|---|---|---|---|
| | ASSEMBLABILITY | AUTOMATION | REPAIR | SAVING | RELIABILITY | RESISTANCE |
| FIRST | D | D | C | B | C | D |
| COMPARATIVE | | | | | | |
| EXAMPLE | | | | | | |
| SECOND | D | C | D | B | D | D |
| COMPARATIVE | | | | | | |
| EXAMPLE | | | | | | |
| THIRD | C | D | B | D | B | B |
| COMPARATIVE | | | | | | |
| EXAMPLE | | | | | | |
| PRESENT | A | A | A | B | A | A |
| EMBODIMENT | | | | | | |

Regarding the assemblability, the connection methods of the first and second comparative examples are rated low, the connection method of the third comparative example is rated intermediate, and the connection method of the present embodiment is rated highest. In the connection method of the first comparative example, a high-load screwing process is necessary in assembly of the internal substrate 53. In the connection method of the second comparative example, a high-load soldering process is necessary in assembly of the internal substrate 63. In the connection method of the third comparative example, cable connection with an intermediate level of load is necessary in assembly of the internal substrate 73. In the connection method of the present embodiment, the internal substrate 17 can be assembled by the lowest-load process of inserting the tip ends of the bus bars 27 of the external connector 20 into the socket openings 34 of the internal connector 30.

Regarding the automation, the connection methods of the first and third comparative examples are rated low, the connection method of the second comparative example is rated intermediate, and the connection method of the present embodiment is rated highest. The screwing process of the connection method of the first comparative example and the cable connection process of the connection method of the third comparative example are not suitable for the automation. The soldering process of the connection method of the second comparative example can be automated. However, it is difficult to automatically properly adjust, e.g., a solder amount. In the connection method of the present embodiment, the internal substrate 17 approaches the case 10 from above, and in this manner, the internal substrate 17 is connected to the external connector 20. Thus, automation of an assembly process can be easily realized by an automatic machine such as a robot arm.

Regarding the repair, the connection method of the first comparative example is rated intermediate, the connection method of the second comparative example is rated low, the connection method of the third comparative example is rated high, and the connection method of the present embodiment is rated highest. In the connection method of the first comparative example, a screw detachment process with an intermediate level of load is necessary in replacement of the internal substrate 53. In the connection method of the second comparative example, it is difficult to replace the internal substrate 63 soldered to the bus bars 62 of the external connector 61. In the connection method of the third comparative example, the internal substrate 17 can be replaced by a low-load cable detachment process. In the connection method of the present embodiment, the internal substrate 17 can be replaced by the lowest-load process of pulling up the internal substrate 17 from the case 10.

Regarding the space saving, the connection methods of the first and second comparative examples are rated high, the connection method of the third comparative example is rated low, and the connection method of the present embodiment is rated high. In the connection method of the first comparative example, the bus bars 52 are bent in the crank shape. In the connection method of the second comparative example, the bus bars 62 are bent in the right-angle shape. Thus, in the connection methods of the first and second comparative examples, the space saving can be realized. In the connection method of the third comparative example, an installation space for the cable 75 needs to be ensured, and for this reason, it is difficult to realize the space saving. In the connection method of the present embodiment, the bus bars 27 are bent in the right-angle shape, and therefore, the space saving can be realized as in the first and second comparative examples.

Regarding the contact reliability, the connection method of the first comparative example is rated intermediate, the connection method of the second comparative example is rated low, the connection method of the third comparative example is rated high, and the connection method of the present embodiment is rated highest. In the connection method of the first comparative example, there is a probability that contact failure is caused due to loosening of the screws. In the connection method of the second comparative example, contact failure is relatively easily caused at a soldering portion due to fatigue failure. In the connection method of the third comparative example, cable connection is employed, and for this reason, there is a low probability that contact failure is caused at a connection portion. In the connection method of the present embodiment, multipoint contact that the bus bar 27 is sandwiched by the pair of contact terminals 44 is employed, and therefore, the risk of the contact failure can be most reduced.

Regarding the vibration resistance, the connection methods of the first and second comparative examples are rated low, the connection method of the third comparative example is rated high, and the connection method of the present embodiment is rated highest. In the connection method of the first comparative example, there is a probability that loosening of the screws is caused due to vibration transmitted to a screwing location. In the connection method of the second comparative example, there is a probability that the soldering portion is damaged due to vibration transmitted to the soldering portion. In the connection method of the third comparative example, cable connection is employed, and therefore, influence of vibration is small. In the connection method of the present embodiment, the internal connector 30 employs the floating structure. Thus, the floating structure absorbs vibration, and therefore, connection between the internal substrate 17 and the external connector 20 can be favorably maintained.

As described above, according to the present embodiment, the tip end side of the bus bars 27 of the external connector 20 is inserted into the socket openings 34 of the internal connector 30, and in this manner, the bus bars 27 and the contact terminals 44 contact each other and the external connector 20 and the internal substrate 17 are electrically connected to each other. With this configuration, size reduction in the in-vehicle equipment is realized, and connection between the external connector 20 and the internal substrate 17 is simplified. Moreover, before the internal connector 30 is connected to the pair of bus bars 27 of the external connector 20, the external connector 20 is fixed to the case 10. With this configuration, waterproofing can be performed for the periphery of the external connector 20 in advance. Further, the contact terminals 44 and the tip end side of the bus bars 27 are housed in the socket openings 34, and therefore, the dust resistance is ensured. Thus, even in a case where the in-vehicle equipment is used under the harsh environment, connection between the external connector 20 and the internal substrate 17 is maintained.

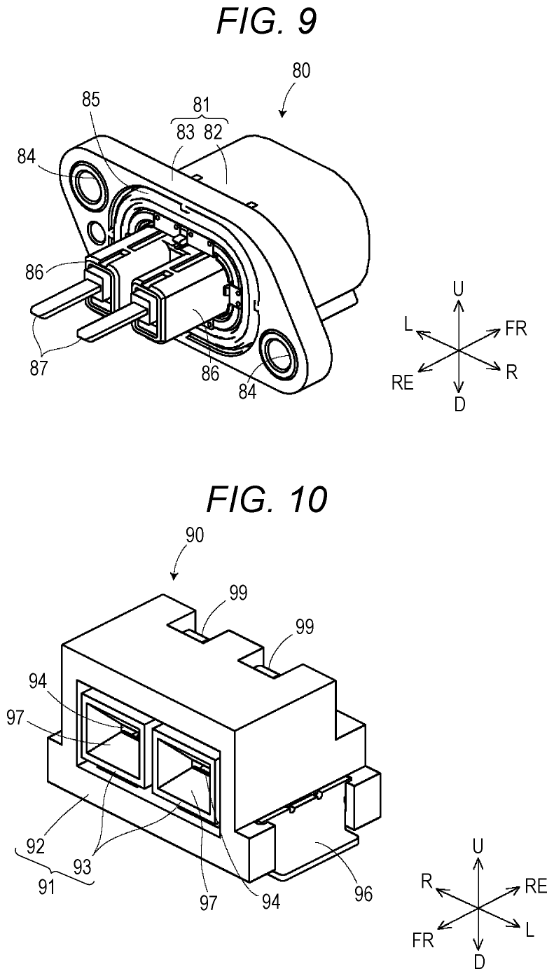

Note that in the present embodiment, after the external connector 20 has been fixed to the case 10, the internal substrate 17 is placed in the case 10, and the tip ends of the bus bars 27 of the external connector 20 are inserted into the socket openings 34 of the internal connector 30. However, the order of these processes is not limited to above. As illustrated in a variation of FIGS. 9 to 11A and 11B, after the internal substrate 17 has been placed in the case 10, an external connector 80 may be fixed to the case 10, and tip ends of bus bars 87 of the external connector 80 may be inserted into socket openings 94 of an internal connector 90.

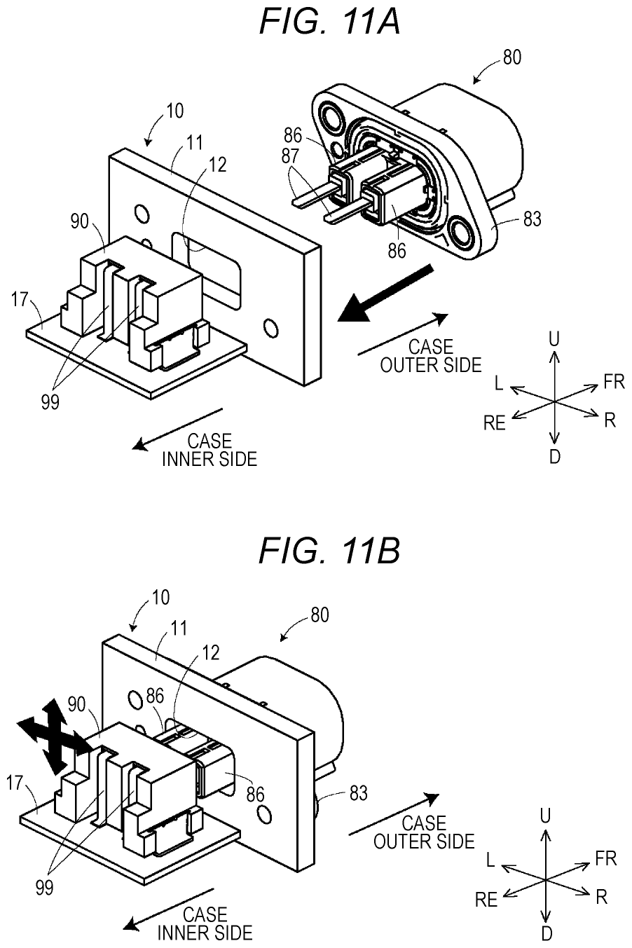

Hereinafter, the variation will be described. FIG. 9 is a perspective view of the external connector of the variation. FIG. 10 is a perspective view of the internal connector of the variation. FIG. 11A is a perspective view illustrating a connector assembly method of the variation. FIG. 11B is a perspective view illustrating the connector assembly method of the variation. Note that description of configurations of the variation similar to those of the present embodiment will be omitted as much as possible.

As illustrated in FIG. 9, the external connector 80 of the variation is different from the external connector 20 of the present embodiment in that the bus bars 87 are formed in a straight shape. That is, a housing 81 of the external connector 80 has a tubular portion 82 formed with a fitting port and a flange portion 83 formed with insertion holes 84 for screwing. A pair of support portions 86 is provided at a rear end portion of the housing 81. The straight bus bar 87 extends from a rear end of each support portion 86. Moreover, a waterproof seal 85 is provided at the periphery of the pair of support portions 86. The waterproof seal 85 liquid-tightly seals between the side wall 11 of the case 10 and the housing 81.

As illustrated in FIG. 10, the internal connector 90 of the variation is different from the internal connector 30 of the present embodiment in that a pair of movable housings 93 is supported in a landscape orientation on a fixed housing 92. That is, a socket housing 91 has the rectangular frame-shaped fixed housing 92 opening at one side surface and the pair of movable housings 93. The socket openings 94 of the pair of movable housings 93 are exposed through the opening at one side surface of the fixed housing 92. A pair of fixing brackets 96 fixed to the internal substrate 17 is provided at both ends of the fixed housing 92 in the right-left direction. A guide surface 97 is formed at a side surface of the movable housing 93. The guide surface 97 guides the bus bar 87 toward the socket opening 94. Moreover, although not described in detail, each movable housing 93 is supported in a floating state by a pair of L-shaped floating springs 99.

As illustrated in FIG. 11A, in the connector assembly method of the variation, the internal substrate 17 is placed in the case 10 by, e.g., screwing. In this state, the pair of socket openings 94 (see FIG. 10) of the internal connector 90 on the internal substrate 17 is laterally exposed through the though-hole 12 of the case 10. After the internal substrate 17 has been fixed to the case 10, the pair of bus bars 87 of the external connector 80 is positioned at the front of the pair of socket openings 94. Tip ends of the pair of bus bars 87 of the external connector 80 are, at the side of the case 10, positioned relative to the pair of socket openings 94 at a side surface of the internal connector 90. Then, the external connector 80 is moved toward the case 10. In this manner, the tip ends of the pair of bus bars 87 of the external connector 80 approach the pair of socket openings 94 of the internal connector 90. At this point, the tip ends of the pair of bus bars 87 of the external connector 80 are guided to the pair of socket openings 94 by the guide surfaces 97 (see FIG. 10) of the internal connector 90.

As illustrated in FIG. 11B, the movable housings 93 (see FIG. 10) of the internal connector 90 are moved to follow tip end positions of the pair of bus bars 87 of the external connector 80. By such movement, e.g., position displacement of the internal substrate 17 relative to the case 10 is absorbed. Moreover, contact terminals (not shown) in the pair of socket openings 94 and the pair of bus bars 87 contact each other to form the connector assembly. Thereafter, the external connector 80 is fixed to the side wall 11 of the case 10 by, e.g., screwing. In this manner, the in-vehicle equipment is assembled. As described above, even in the connector assembly method of the variation, a tip end side of the pair of bus bars 87 of the external connector 80 is inserted into the pair of socket openings 94 of the internal connector 90 as in the connector assembly method of the present embodiment, and therefore, the external connector 80 and the internal substrate 17 can be easily connected to each other.

In the present embodiment and the variation, the floating connector has been described as an example of the internal connector. However, the internal connector is not limited to the floating connector. In the present embodiment and the variation, even when the internal connector is not the floating connector, a high rating can be obtained in terms of five points of the assemblability, the automation, the repair, the space saving, and the contact reliability.

Moreover, in the present embodiment and the variation, the external connector and the internal connector may be any of power connectors configured to receive power from an external power source and signal connectors configured to receive a signal from external equipment.

Further, in the present embodiment and the variation, the clip-shaped terminals are provided in the socket opening. On this point, the contact terminal in the socket opening is not necessarily the clip-shaped terminal.

In addition, in the present embodiment and the variation, the guide surfaces are formed at the internal connector. However, the guide surfaces are not necessarily formed at the internal connector.

Moreover, in the present embodiment and the variation, the internal substrate is connected to the external connector from above. Instead, the internal substrate may be connected to the external connector from below.

Further, in the present embodiment and the variation, the pair of bus bars as the leads extends from the external connector. Instead, a single lead may extend from the external connector. Alternatively, three or more leads may extend from the external connector.

In addition, in the present embodiment and the variation, the in-vehicle equipment has been described as an example of the equipment. On this point, the equipment may be other types of equipment, such as industrial equipment.

As described above, the connector assembly method of the present embodiment includes connecting the external connector (20, 80) fixed to the case (10) of the equipment and the internal connector (30, 90) on the internal substrate (17) in the case. In this connector assembly method, the lead (the bus bar 27, 87) extending inward of the case is provided at the external connector. Moreover, the contact terminal (44) is provided in the socket opening (34, 94) formed at the internal connector. Further, the connecting the external connector and the internal connector includes inserting the tip end side of the lead into the socket opening in such a manner that the socket opening of the internal connector and the tip end of the lead of the external connector relatively approach each other. According to this method, the tip end side of the lead of the external connector is inserted into the socket opening of the internal connector, and in this manner, the lead and the contact terminal contact each other and the external connector and the internal substrate are electrically connected to each other. With this configuration, size reduction in the equipment is realized, and connection between the external connector and the internal substrate is simplified. Further, the contact terminal and the tip end side of the lead are housed in the socket opening, and therefore, the dust resistance is ensured. Thus, even in a case where the equipment is used under the harsh environment, connection between the external connector and the internal substrate is maintained.

In the connector assembly method of the present embodiment, the internal connector may be the floating connector, and the movable housing (33, 93) may be supported in the floating state in the fixed housing (32, 92) fixed to the internal substrate through the floating spring (41, 99). According to this method, position displacement of the external connector relative to the case, position displacement of the internal connector relative to the internal substrate, and position displacement of the internal substrate relative to the case are absorbed by movement of the movable housing relative to the fixed housing. Moreover, by the floating spring, vibration transmitted to the in-vehicle equipment is absorbed. With this configuration, connection between the lead of the external connector and the contact terminal of the internal connector is maintained.

In the connector assembly method of the present embodiment, the clip-shaped terminals as the pair of contact terminals may be formed in the socket opening. According to this method, the lead is sandwiched by the pair of contact terminals. Thus, even in a case where the in-vehicle equipment is used under the harsh environment, the contact reliability is improved by multipoint contact among the contact terminals and the lead.

In the connector assembly method of the present embodiment, the guide surface (37, 97) configured to guide the tip end side of the lead may be formed toward the socket opening at the internal connector. According to this method, the tip end of the lead contacts the guide surface of the internal connector. With this configuration, the tip end of the lead is guided to the socket opening by the guide surface. Thus, the tip end side of the lead is easily inserted into the socket opening.

In the connector assembly method of the present embodiment, the tip end side of the lead may be bent perpendicularly to the base end side of the lead. According to this method, the internal connector approaches the external connector from the direction perpendicular to an internal connector attachment direction so that the external connector and the internal connector can be connected to each other.

In the connector assembly method of the present embodiment, the inserting the tip end side of the lead into the socket opening may include causing, after the external connector has been fixed to the case, the socket opening of the internal connector to approach the tip end of the lead of the external connector. According to this method, the internal substrate can be placed in the case after the external connector has been fixed to the case.

In the connector assembly method of the present embodiment, the external connector may be fixed to the side wall of the case, and the tip end of the lead may face up. The inserting the tip end side of the lead into the socket opening may include causing the socket opening of the internal connector to approach the tip end of the lead of the external connector from above. According to this method, on, e.g., the in-vehicle equipment production line, the workability in the assembly process can be improved. Further, the assembly process can be automated by the automatic machine.

In the connector assembly method of the present embodiment, the lead includes the multiple leads extending inward of the case from the external connector. The socket opening may include the multiple socket openings formed at the internal connector. The contact terminals may be provided in each socket opening. According to this configuration, the multiple leads of the external connector and the contact terminals in the multiple socket openings of the internal connector can be easily connected to each other.

In the in-vehicle equipment in the in-vehicle equipment assembly method of the present embodiment, the external connector is fixed to the case, and the internal substrate is placed in the case. The lead extending inward of the case is provided at the external connector. The internal connector is provided on the internal substrate. The contact terminal is provided in the socket opening formed at the internal connector. This assembly method includes fixing the external connector to the case and placing the internal substrate in the case such that the tip end side of the lead is inserted into the socket opening in such a manner that the socket opening of the internal connector and the tip end of the lead of the external connector relatively approach each other. According to this method, size reduction in the in-vehicle equipment is realized, and connection between the external connector and the internal substrate is simplified. Further, even in a case where the in-vehicle equipment is used under the harsh environment, connection between the external connector and the internal substrate is maintained.

The connector assembly of the present embodiment includes the external connector fixed to the case of the equipment, and the internal connector provided on the internal substrate in the case. The lead extending inward of the case is provided at the external connector. The contact terminal is provided in the socket opening formed at the internal connector. The internal connector and the external connector are formed in such shapes that the tip end side of the lead is insertable into the socket opening in such a manner that the socket opening of the internal connector and the tip end of the lead of the external connector relatively approach each other. According to this configuration, size reduction in the equipment is realized, and connection between the external connector and the internal substrate is simplified. Further, even in a case where the equipment is used under the harsh environment, connection between the external connector and the internal substrate is maintained.

The in-vehicle equipment of the present embodiment includes the case, the external connector fixed to the case, the internal substrate placed in the case, and the internal connector provided on the internal substrate. The lead extending inward of the case is provided at the external connector. The contact terminal is provided in the socket opening formed at the internal connector. The internal connector and the external connector are formed in such shapes that the tip end side of the lead is insertable into the socket opening in such a manner that the socket opening of the internal connector and the tip end of the lead of the external connector relatively approach each other. According to this configuration, size reduction in the in-vehicle equipment is realized, and connection between the external connector and the internal substrate is simplified. Further, even in a case where the in-vehicle equipment is used under the harsh environment, connection between the external connector and the internal substrate is maintained.

The present embodiment and the variation have been described above. Other embodiments of the present disclosure may be those obtained by entirely or partially combining the present embodiment and the variation described above.

Moreover, the technique of the present disclosure is not limited to the above-described embodiment. The above-described embodiment may be changed, replaced, or modified in various manners without departing from the gist of the technical idea. Further, in a case where the technical idea can be implemented in another way by development of the technique or another derived technique, the technique of the present disclosure may be implemented using such a method. Thus, the scope of the claims covers all embodiments included in the scope of the technical idea.

What is claimed is:

1. A connector assembly method comprising:
connecting an external connector fixed to a case of equipment and an internal connector on an internal substrate in the case,
wherein a lead extending inward of the case is provided at the external connector,
a contact terminal is provided in a socket opening formed at the internal connector, and
the connecting the external connector and the internal connector includes inserting a tip end side of the lead into the socket opening in such a manner that the socket opening of the internal connector and a tip end of the lead of the external connector relatively approach each other.

2. The connector assembly method according to claim 1, wherein
the internal connector is a floating connector, and
a movable housing is supported in a floating state in a fixed housing fixed to the internal substrate through a floating spring.

3. The connector assembly method according to claim 1, wherein
clip-shaped terminals as a pair of contact terminals are formed in the socket opening.

4. The connector assembly method according to claim 1, wherein
a guide surface configured to guide the tip end side of the lead is formed toward the socket opening at the internal connector.

5. The connector assembly method according to claim 1, wherein
the tip end side of the lead is bent perpendicularly to a base end side of the lead.

6. The connector assembly method according to claim 5, wherein
the inserting the tip end side of the lead into the socket opening includes causing, after the external connector has been fixed to the case, the socket opening of the internal connector to approach the tip end of the lead of the external connector.

7. The connector assembly method according to claim 6, wherein
the external connector is fixed to a side wall of the case, and the tip end of the lead faces up, and
the inserting the tip end side of the lead into the socket opening includes causing the socket opening of the internal connector to approach the tip end of the lead of the external connector from above.

8. The connector assembly method according to claim 1, wherein
the lead includes multiple leads extending inward of the case from the external connector,
the socket opening includes multiple socket openings formed at the internal connector, and
the contact terminals are provided in each socket opening.

9. An in-vehicle equipment assembly method,
in-vehicle equipment,
an external connector being fixed to a case and an internal substrate being placed in the case,
a lead extending inward of the case being provided at the external connector,
an internal connector being provided on the internal substrate, and
a contact terminal being provided in a socket opening formed at the internal connector, the method comprising:
fixing the external connector to the case and placing the internal substrate in the case such that a tip end side of the lead is inserted into the socket opening in such a manner that the socket opening of the internal connector and a tip end of the lead of the external connector relatively approach each other.

10. A connector assembly comprising:
an external connector fixed to a case of equipment; and
an internal connector provided on an internal substrate in the case,
wherein a lead extending inward of the case is provided at the external connector,
a contact terminal is provided in a socket opening formed at the internal connector, and
the internal connector and the external connector are formed in such shapes that a tip end side of the lead is insertable into the socket opening in such a manner that the socket opening of the internal connector and a tip end of the lead of the external connector relatively approach each other.

11. In-vehicle equipment comprising:
a case;
an external connector fixed to the case;
an internal substrate placed in the case; and
an internal connector provided on the internal substrate,
wherein a lead extending inward of the case is provided at the external connector,
a contact terminal is provided in a socket opening formed at the internal connector, and
the internal connector and the external connector are formed in such shapes that a tip end side of the lead is insertable into the socket opening in such a manner that the socket opening of the internal connector and a tip end of the lead of the external connector relatively approach each other.
